(19) United States
(12) Patent Application Publication
(10) Pub. No.: US 2025/0130691 A1
(43) Pub. Date: Apr. 24, 2025

(54) STORAGE MEDIUM

(71) Applicant: TOYOTA JIDOSHA KABUSHIKI KAISHA, Toyota-shi (JP)

(72) Inventors: Kei KOSAKA, Tokyo (JP); Hironori AOKAGE, Nagoya-shi (JP); Tatsuya MAEMURA, Nisshin-shi (JP); Ryosuke MATSUOKA, Nishinomiya-shi (JP)

(73) Assignee: TOYOTA JIDOSHA KABUSHIKI KAISHA, Toyota-shi (JP)

(21) Appl. No.: 18/883,028

(22) Filed: Sep. 12, 2024

(30) Foreign Application Priority Data
Oct. 23, 2023 (JP) 2023-181656

(51) Int. Cl. G06F 3/0482; G06F 3/0484

(52) U.S. Cl. CPC G06F 3/0482; G06F 3/0484

(57) ABSTRACT

The program is installed in a terminal used by the user. The program causes the terminal to accept designation of a vehicle desired by the user from among a plurality of vehicles related to the user. The program causes the terminal to display a list of cameras mounted on the designated vehicle. The program causes the terminal to accept an operation of selecting a camera desired by the user from the list of cameras. The program causes the terminal to reproduce the video of the selected camera in response to the user's acceptance of the operation of selecting the desired camera.

### CROSS-REFERENCE TO RELATED APPLICATION

This application claims priority to Japanese Patent Application No. 2023-181656 filed on Oct. 23, 2023, incorporated herein by reference in its entirety.

### BACKGROUND

### 1. Technical Field

The present disclosure relates to a storage medium.

### 2. Description of Related Art

There is known a system for issuing an alarm when a suspicious person is detected in a video shot by a shooting device, and technology for changing a detection range of the suspicious person in accordance with a parked position of a vehicle (e.g., see Japanese Unexamined Patent Application Publication No. 2020-149088 (JP 2020-149088 A)).

### SUMMARY

An object of the present disclosure is to provide technology that is capable of improving convenience for a user in a service for distributing video shot by an in-vehicle camera while parked.

One aspect of the present disclosure can be understood as a storage medium storing a program installed in a terminal used by a user. The program in this case is configured to cause the terminal used by the user to execute
accepting designation of a vehicle desired by the user, from among a plurality of vehicles associated with the user,
displaying a list of cameras installed in the vehicle that is designated,
accepting an operation of selecting a camera desired by the user from the list, and
performing playback of a video of the camera that is selected.

The present disclosure can also be understood to be a terminal that executes the above-described program, a method in which the terminal executes processing defined by the above-described program, or a non-transitory storage medium that stores the above-described program.

According to the present disclosure, technology can be provided that is capable of improving convenience for a user in a service for distributing video shot by an in-vehicle camera while parked.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a system according to an embodiment;

FIG. 2 is a diagram schematically illustrating an example of a hardware configuration of a user terminal according to the embodiment;

FIG. 3 is a diagram schematically illustrating an example of a software configuration of a user terminal according to the embodiment;

FIG. 4 is a diagram illustrating an example of vehicle data held in a storage unit of a user terminal according to the embodiment;

FIG. 5 is a diagram illustrating an exemplary transition of a screen displayed by the user terminal according to the embodiment; and

FIG. 6 is a flowchart illustrating a processing flow executed by the user terminal according to the embodiment.

### DETAILED DESCRIPTION OF EMBODIMENTS

As a service for securing security of a parked vehicle, a service for distributing a video captured by an in-vehicle camera to a user's terminal in real time while the vehicle is parked is being developed. In such a service, the user of the vehicle can grasp the current state of the parked vehicle from a remote location.

The number and/or type of in-vehicle cameras differ for each vehicle. As an example, a vehicle that implements only a camera that photographs a front side of a vehicle, a vehicle that implements only a camera that photographs a rear side of a vehicle, and a vehicle that implements only a camera that photographs an inside of a vehicle can be serviced. Further, a vehicle or the like that implements at least two cameras among the plurality of cameras may also be an object of service. Therefore, in order to ensure the convenience of the user in the above-described service, a user interface according to the number and/or type of cameras implemented in the vehicle in which the user wants to view video is required.

Therefore, the program according to the present disclosure is configured to cause a terminal (hereinafter, sometimes referred to as a “user terminal”) used by a user to execute, from among a plurality of vehicles related to the user, accepting designation of a vehicle desired by the user, displaying a list of cameras mounted on the designated vehicle, accepting an operation of selecting a camera desired by the user from the list, and reproducing a video of the selected camera.

Here, the plurality of vehicles associated with the user may include vehicles in which the user has ownership and/or vehicles in which the user has usage rights. In order to accept the designation of the vehicle desired by the user from the plurality of vehicles, for example, a list of the plurality of vehicles may be displayed on the user terminal, and an operation of designating the vehicle desired by the user from the displayed list may be accepted by the user terminal.

The program according to the present disclosure causes the user terminal to display a list of cameras mounted on the designated vehicle in response to the user terminal accepting the designation of the vehicle desired by the user. Note that the information on the number and type of cameras mounted on each of the plurality of vehicles associated with the user may be registered in advance in a storage unit of the user terminal or the like, or may be acquired from an external server. Thus, the user terminal can present a list including only the cameras actually mounted on the vehicle desired by the user to the user. That is, the user terminal can realize a user interface according to the number and/or type of cameras implemented in the vehicle in which the user wants to view a video through execution of the program according to the present disclosure.

When a list of cameras mounted on a vehicle desired by the user is displayed by the user terminal and an operation of selecting a camera desired by the user from the list is performed, the program according to the present disclosure causes the user terminal to receive the operation. Accordingly, the program according to the present disclosure causes the user terminal to reproduce the video of the selected camera. The video of the selected camera may be directly distributed from the designated vehicle to the user terminal, or may be indirectly distributed from the designated vehicle to the user terminal via the external server.

According to the program of the present disclosure, it is possible to realize a user interface according to the number and/or type of cameras mounted on a vehicle in which a user wants to view a video. Accordingly, it is possible to improve the convenience of the service for providing the user terminal with the video captured by the in-vehicle camera being parked.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

In the present embodiment, an example in which the program according to the present disclosure is applied to a system for providing a service (hereinafter, sometimes referred to as “parking monitoring service”) for delivering a video captured by an in-vehicle camera in real time while a vehicle is parked will be described.

### Summary of System

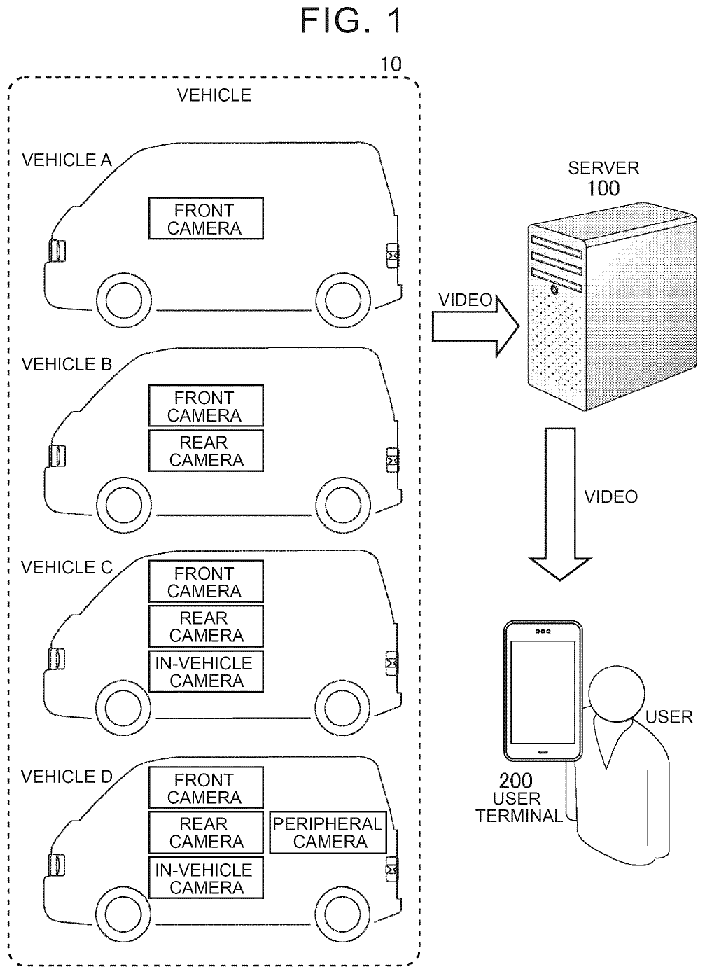

FIG. 1 is a diagram illustrating an outline of a system according to the present embodiment. The system according to the present embodiment includes a vehicle 10, a server 100, and a user terminal 200. The vehicle 10, the server 100, and the user terminal 200 are connected to each other through a network. The network is, for example, a WAN or another communication network that is a global public communication network such as the Internet.

The vehicle 10 is a vehicle associated with a user. A vehicle associated with a user may, in one example, be a vehicle in which the user has ownership or usage rights. Vehicles in which the user has ownership or usage rights may include company vehicles in which the user works. Note that the number of vehicles 10 associated with the user is not limited to one, and may be a plurality of vehicles. In the example illustrated in FIG. 1, the vehicle 10 associated with the user includes a plurality of vehicles A, B, C, and D.

Each of the vehicles 10 associated with the user implements an in-vehicle camera. The number and type of in-vehicle cameras may vary from vehicle to vehicle. In the example shown in FIG. 1, only the front camera is mounted on the vehicle A, and only the front camera and the rear camera are mounted on the vehicle B. In the example illustrated in FIG. 1, only the front camera, the rear camera, and the in-vehicle camera are mounted on the vehicle C, and the front camera, the rear camera, the in-vehicle camera, and the surrounding camera are mounted on the vehicle D. That is, the number and types of cameras to be mounted differ between the vehicles A to D.

The front camera is a camera that captures an image of the front of the vehicle 10. The rear camera is a camera that captures an image of the rear of the vehicle 10, and the in-vehicle camera is a camera that captures an image of the inside (interior) of the vehicle 10. The surrounding camera is a camera (for example, a 360-degree camera) that captures images of the front, rear, left, and right sides of the vehicle 10.

Note that the number of vehicles 10 related to the user, the number of cameras mounted on each vehicle 10, the type of cameras mounted on each vehicle 10, and the like are not limited to the example illustrated in FIG. 1, and may vary depending on the user who is the target of the parking monitoring service.

Each of the vehicles 10 in the present embodiment has a function of transmitting a video captured by a camera desired by the user to the server 100 in real time in response to a command from the server 100 described later.

The server 100 is a computer operated by a provider of a parking monitoring service. The server 100 of the present embodiment has a function of receiving a delivery request from the user terminal 200. The delivery request includes information specifying the vehicle 10 that the user wants to view the video, information specifying the camera that the user wants to view the video, and the like. The information specifying the vehicle 10 that the user wants to view the video may be information specifying any one of the vehicles 10 associated with the user. Further, the information specifying the camera to which the user wants to view the video may be information specifying any one of the cameras mounted on the specified vehicle 10. Here, in a case where the video desired by the user is the video of the rear camera of the vehicle B illustrated in FIG. 1, the distribution request may include information specifying the vehicle B and information specifying the rear camera.

The server 100 of the present embodiment also has a function of acquiring a video corresponding to the received distribution request from the vehicle 10 and distributing the acquired video to the user terminal 200 in real time. Specifically, the server 100 transmits a command signal for causing the vehicle 10 designated by the delivery request to transmit the video of the camera designated by the delivery request to the server 100 in real time. Next, upon receiving the video transmitted from the vehicle 10 in response to the command signal, the server 100 distributes (relays) the received video to the user terminal 200 in real time. Here, when the video desired by the user is the video of the rear camera of the vehicle B illustrated in FIG. 1, the server 100 transmits a command signal for causing the vehicle B to transmit the video of the rear camera to the server 100 in real time. Then, the server 100 may distribute the video of the rear camera transmitted from the vehicle B to the user terminal 200 in real time.

The user terminal 200 is a computer used by a user of the vehicle 10. An application program dedicated to the parking monitoring service is installed in the user terminal 200 of the present embodiment. The user terminal 200 performs a function of accepting designation of the vehicle 10 and the camera to which the user wants to view a video through execution of an application program, and transmitting a delivery request corresponding to the designated vehicle 10 and the camera to the server 100. The user terminal 200 also achieves a function of reproducing video distributed from the server 100 through execution of an application program.

### Hardware Configuration of the User Terminal

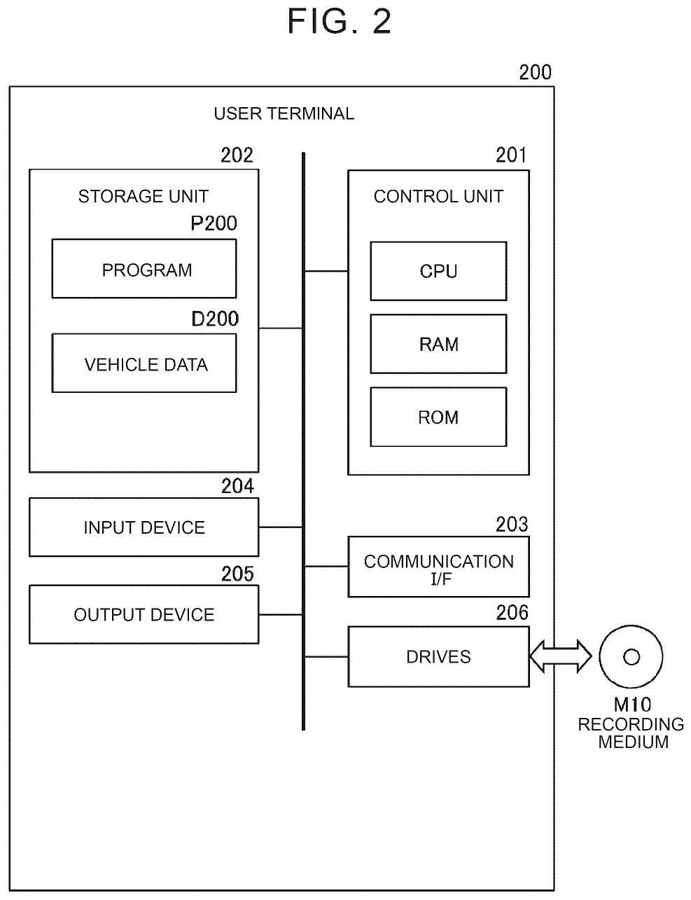

FIG. 2 is a diagram schematically illustrating an example of a hardware configuration of a user terminal 200 according to the present embodiment. The user terminal 200 in the present embodiment is a computer in which the control unit 201, the storage unit 202, the communication interface 203, the input device 204, the output device 205, and the drive 206 are electrically connected to each other. The user terminal 200 having such a hardware configuration may be a smart phone, a Personal Computer (PC), a tablet terminal, or the like.

The control unit 201 includes Central Processing Unit (CPU), Random Access Memory (RAM), Read Only Memory (ROM), and the like, which are hardware processors, and is configured to execute any information processing based on programs and various types of data. The control unit 201 (CPU) is an exemplary processor resource of the user terminal 200.

The storage unit 202 may be constituted by, for example, a hard disk drive, a solid state drive, a semiconductor memory, or the like. The storage unit 202 (and RAM, ROM) is an exemplary memory-resource. In the present embodiment, the storage unit 202 stores various types of data such as a program P200 and a vehicle data D200. The program P200 is an application program dedicated to the parking monitoring service, and is an exemplary “program” according to the present disclosure. The program P200 of the present embodiment is a program for causing the user terminal 200 to execute information processing for reproducing in real time a video captured by the in-vehicle camera while the vehicle 10 is parked. The vehicle data D200 is data relating to the vehicle 10 associated with the user. The vehicle-data D200 will be described later.

The communication interface 203 is configured to perform wired or wireless communication via a network. The communication interface 203 may be constituted by, for example, a wired Local Area Network (LAN) module, a wireless LAN module, or the like. In the present embodiment, the user terminal 200 may perform data communication with the server 100 via the communication interface 203.

The input device 204 is a device for inputting, for example, a mouse, a keyboard, an operation button, and the like. The output device 205 is, for example, a device for outputting a display, a speaker, or the like. The user can operate the user terminal 200 by using the input device 204 and the output device 205. The input device 204 and the output device 205 may be integrally formed of, for example, a touch panel display.

The drive 206 is a device for reading various types of information such as programs stored in the storage medium M10. At least one of the program P200 and the vehicle-data D200 may be stored in the storage medium M10 instead of the storage unit 202. The storage medium M10 is configured to store various kinds of information (such as stored programs) by an electric, magnetic, optical, mechanical, or chemical action so that a machine such as a computer can read the information. The user terminal 200 may acquire at least one of the program P200 and the vehicle-data D200 from the storage medium M10. Note that the storage medium M10 may be a disk-type storage medium such as a CD, DVD, or may be a storage medium other than a disk-type such as a semiconductor memory (for example, a flash memory). The type of the drive 206 may be appropriately selected according to the type of the storage medium M10.

Regarding the specific hardware configuration of the user terminal 200, it is possible to omit, replace, and add constituent elements as appropriate according to the embodiment. For example, the control unit 201 may include a plurality of hardware processors. The hardware processor may be constituted by a microprocessor, a field-programmable gate array (FPGA), a digital signal processor (DSP), a Graphics Processing Unit (GPU), or the like. Further, the drive 206 may be omitted. The vehicle-data D200 may be stored not in the storage unit 202 but in an external computer (for example, a Network Attached Storage (NAS)) accessible to the user terminal 200.

### Software Configuration of the User Terminal

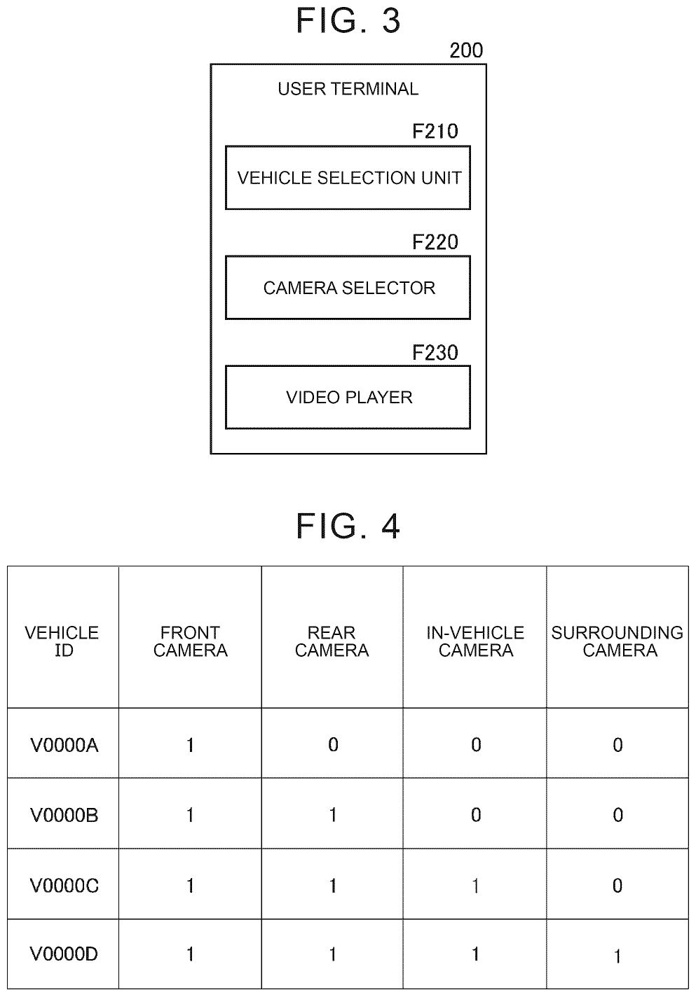

FIG. 3 is a diagram schematically illustrating an example of a software configuration of the user terminal 200 according to the present embodiment. The control unit 201 of the user terminal 200 executes an instruction included in the program P200 by a CPU. Accordingly, the user terminal 200 operates as a computer including the vehicle selection unit F210, the camera-selection unit F220, and the video reproduction unit F230 as software modules.

The vehicle selection unit F210 is configured to interact with a user. In the present embodiment, triggered by the user activating the program P200 (or logging in to the program P200) in the user terminal 200, the vehicle selection unit F210 presents a list of vehicles 10 associated with the user (hereinafter, also referred to as “vehicle list”). Then, the vehicle selection unit F210 receives a designation operation (selection operation) of the vehicle 10 desired by the user from the presented vehicle list. The vehicle list is generated by using the vehicle data D200 held in the storage unit 202 of the user terminal 200.

An exemplary vehicle-data D200 is shown in FIG. 4. The vehicle data D200 has a record corresponding to each of the vehicles 10 associated with the user. In the embodiment shown in FIG. 4, the vehicle data D200 has four records corresponding to each of the vehicles A to D in FIG. 1. The records have fields such as a vehicle ID, a front camera, a rear camera, an in-vehicle camera, and a surrounding camera. In the vehicle ID field, an identifier (vehicle ID) of each of the vehicles 10 associated with the user is registered. In the front camera field, information indicating whether or not each of the vehicles 10 associated with the user is implementing the front camera is registered. In the example illustrated in FIG. 4, “1” is registered in the front camera field for the vehicle 10 on which the front camera is mounted, and “0” is registered in the front camera field for the vehicle 10 on which the front camera is not mounted. In each of the rear camera field, the in-vehicle camera field, and the surrounding camera field, as in the case of the front camera field, information indicating whether or not each of the vehicles 10 associated with the user is implementing the corresponding camera (i.e., “1” in the case of being implemented, and “0” in the case of not being implemented) is registered.

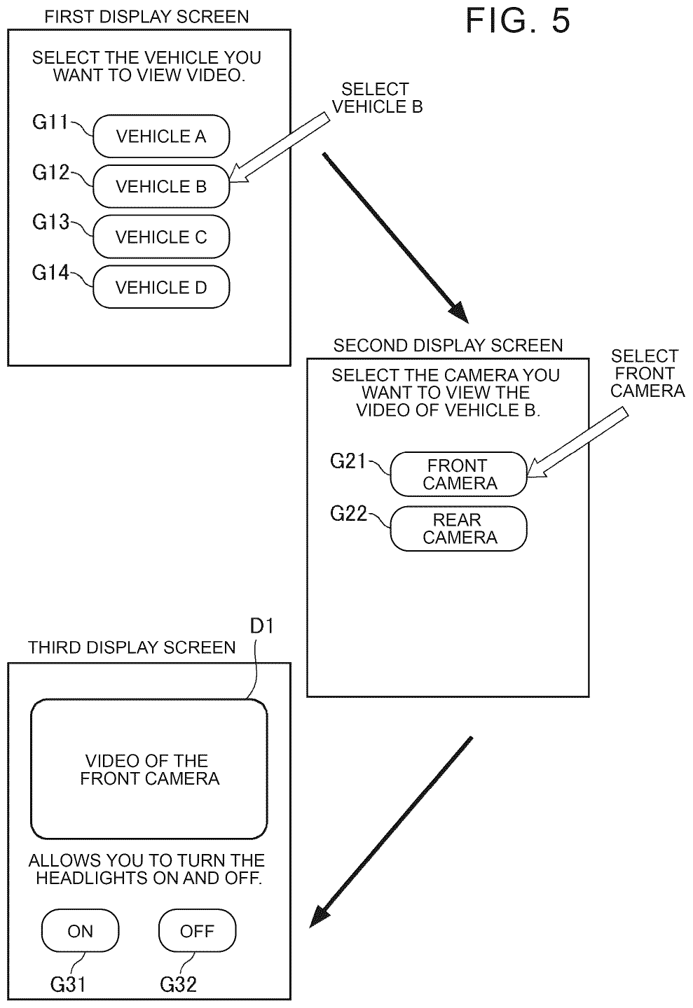

As illustrated in FIGS. 1 and 4, when the vehicle 10 associated with the user includes four vehicles A to D, the vehicle selection unit F210 causes the output device 205 to output (display) the vehicle list including the four vehicles A to D. Here, an example of a display screen of the vehicle list (hereinafter, sometimes referred to as a “first display screen”) is shown in FIG. 5. The first display screen may include a Graphical User Interface (GUI) part including a selection button G11 of the vehicle A, a selection button G12 of the vehicle B, a selection button G13 of the vehicle C, and a selection button G14 of the vehicle D, and a message prompting the user to select the vehicle.

When an operation of designating (selecting) the vehicle 10 desired by the user is input to the input device 204 while the first display screen is being displayed by the output device 205, the control unit 201 of the user terminal 200 operates as a camera selection unit F220 to interact with the user. The operation of specifying (selecting) the vehicle 10 desired by the user is, for example, an operation of clicking or tapping any one of the selection buttons G11 to G14. Specifically, the camera selection unit F220 presents a list of cameras mounted on the vehicle 10 selected by the user (hereinafter, also referred to as a “camera list”) to the user, and receives a designation operation (selection operation) of the vehicle 10 desired by the user from the presented camera list. The camera list is generated by using the vehicle-data D200 stored in the storage unit 202 of the user terminal 200.

Here, when the operation of selecting the vehicle B (selection button G12) is performed on the first display screen illustrated in FIG. 5, the camera selection unit F220 accesses the record of the vehicle B in the vehicle data D200 and specifies the camera mounted on the vehicle B. In FIG. 4, “1” is registered only in the front camera field and the rear camera field among the front camera field, the rear camera field, the in-vehicle camera field, and the surrounding camera field of the record of the vehicle B (the record in which “V0000B” is registered in the vehicle ID field). Therefore, the camera selection unit F220 identifies the front camera and the rear camera as cameras mounted on the vehicle B.

When a camera mounted on the vehicle 10 (for example, the vehicle B) that the user wants to view a video is identified, the camera selection unit F220 causes the output device 205 to output (display) a list of the identified cameras (hereinafter, also referred to as “camera list”). As an example, when an operation of specifying (selecting) the vehicle B (selection button G12) is input to the input device 204 in the first display screen in FIG. 5, the camera selection unit F220 displays a camera list including the front camera and the rear camera through the output device 205.

Here, the display screen of the camera list (hereinafter, sometimes referred to as “second display screen”) may include, as illustrated in FIG. 5, a GUI component including a selection button G21 of the front camera and a selection button G22 of the rear camera, and a message prompting selection of the camera. Note that a camera that is not mounted on the target vehicle 10 (for example, the vehicle B) may be displayed on the second display screen in a form (for example, gray-out) that cannot be selected by the user. Alternatively, it may not be displayed as illustrated in FIG. 5. Examples of cameras that are not mounted on the target vehicle 10 include an indoor camera and an ambient camera.

When an operation of designating (selecting) a camera desired by the user is input to the input device 204 while the second display screen is being displayed by the output device 205, the control unit 201 of the user terminal 200 operates as a video reproduction unit F230, and presents a real-time video of the designated camera to the user. The camera desired by the user is, for example, any one of a front camera and a rear camera. The operation of specifying (selecting) is, for example, an operation of clicking or tapping any one of G22 from the selection-button G21.

Here, when an operation of selecting a front camera (selection button G21) is performed on the second display screen illustrated in FIG. 5, the video reproduction unit F230 transmits a distribution request including information specifying the vehicle B and the front camera to the server 100 through the communication interface 203. Upon receiving the delivery request, the server 100 transmits, to the vehicle B, a command signal for causing the server 100 to transmit a video captured by the front camera in real time. Upon receiving the command signal from the server 100, the vehicle B transmits a video captured by the front camera to the server 100 in real time. The server 100 that has received the video of the vehicle B transmits (relays) the received video to the user terminal 200 in real time.

When the video relayed by the server 100 is received by the communication interface 203 of the user terminal 200, the video reproduction unit F230 displays a third display screen including the reproduction screen of the video received from the server 100 through the output device 205. Here, when the vehicle B and the front camera are respectively selected on the first display screen and the second display screen illustrated in FIG. 5, the video reproduction unit F230 displays a third display screen including a real-time video reproduction screen captured by the front camera of the vehicle B through the output device 205.

As illustrated in FIG. 5, the third display screen may include a playback screen (D1 in FIG. 5) of a video captured by the front camera of the vehicle B, and a GUI component (G31 to G32 in FIG. 5) for switching on/off of a predetermined device. If the camera selected by the user is a front camera, the predetermined device may be a headlight. GUI components for switching on/off a given device may include an on-button G31 and an off-button G32 of the headlight. When the camera selected by the user is a rear camera, the predetermined device may be a backlight. GUI component for switching on/off the predetermined device may then include a backlight on button and an off button. When the camera selected by the user is an in-vehicle camera, the predetermined device may be a room lamp (indoor lamp). GUI component for switching on/off the predetermined device may then include an on button and an off button of the room lamp. In addition, when the camera selected by the user is an ambient camera, the predetermined device may include a plurality of lights such as a headlight, a backlight, and a welcome light (for example, a lamp mounted on a door mirror or the like to illuminate the side of the vehicle 10). GUI component for switching on/off the predetermined device may include on and off buttons of the plurality of lights.

When an operation for turning on/off a predetermined device is input to the input device 204 while the third display screen is being displayed by the output device 205, the video reproducing unit F230 transmits an operation request for turning on or off the predetermined device to the server 100. The operation of turning on/off the predetermined device is, for example, an operation of clicking or tapping the on-button G31 or the off-button G32 of the headlight on the third display screen in FIG. 5. Upon receiving the operation request, the server 100 transmits, to the target vehicle (for example, the vehicle B), a command signal for causing a predetermined device to perform an operation in accordance with the operation designated by the operation request. The vehicle 10 (e.g., vehicle B) that has received such a command signal operates (e.g., turns on or off the headlight) a predetermined device in accordance with the command signal. As a result, the video displayed on the third display screen of the user terminal 200 is a video captured in a state in which a predetermined device is turned on or off. Here, for example, in a case where the surroundings of the vehicle 10 are dark, such as at night or indoors, the user can irradiate the photographing direction of the camera with a predetermined device by remote control. The predetermined device is, for example, at least one of a headlight, a backlight, a room lamp, a welcome lamp, and the like. As a result, the video played back on the third display screen can be made clearer.

Note that the above-described reproduction of the video may be continued until an operation of stopping reproduction by the user (for example, an operation of terminating the program P200 or the like) is input to the input device 204, but may be automatically stopped when a predetermined time length has elapsed from the start of reproduction. The predetermined time length may be arbitrarily set according to the embodiment. As an example, the predetermined time length may be set according to the image quality of the video of the target camera. That is, the higher the video quality of the image of the target camera, the shorter the predetermined time length may be set. As a result, the reproduction time of the above-described video becomes shorter as the image quality of the video becomes higher. This is because the higher the video quality of the image of the camera of interest, the higher the amount of data communication transmitted and received per unit time between the vehicle 10, the server 100, and the user terminal 200 may be, and the higher the communication traffic may be. In the embodiment in which a predetermined time length is set in accordance with the image quality of the video of the target camera, the information regarding the image quality of each camera mounted on each of the vehicles 10 associated with the user may be registered in the vehicle data D200.

### Processing Flow

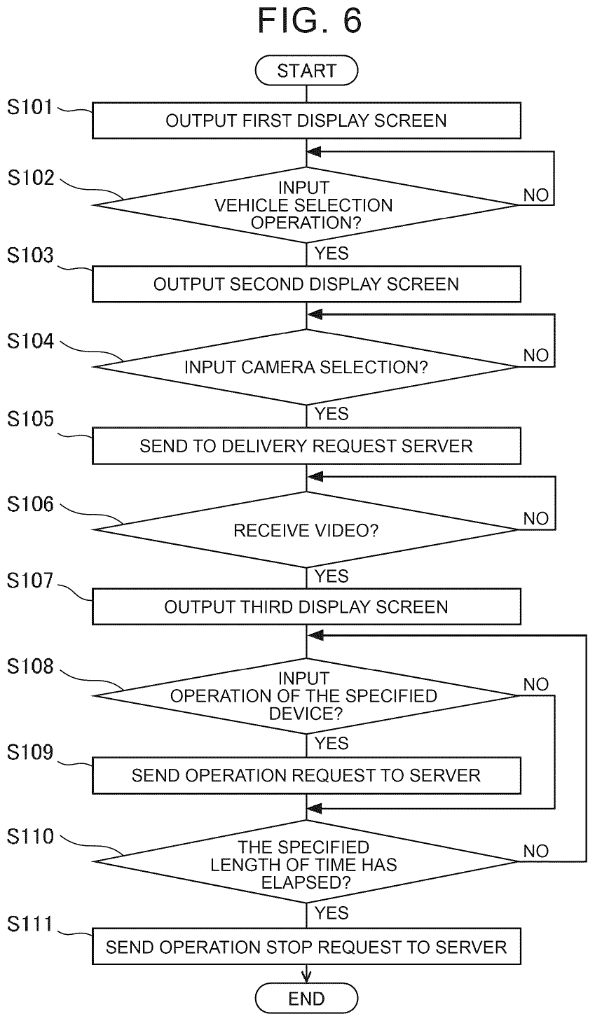

A flow of processing executed by the user terminal 200 according to the present embodiment will be described with reference to FIG. 6. FIG. 6 is a flow chart showing a processing flow when the control unit 201 of the user terminal 200 operates in accordance with an instruction included in the program P200. The process of FIG. 6 is executed by triggering activation of the program P200 (or logging into the program P200). Note that the execution subject of the processing flow of FIG. 6 is the control unit 201 of the user terminal 200, and the software module of the user terminal 200 is described here as the execution subject.

When the user activates the program P200 (or logs into the program P200) in the user terminal 200, the control unit 201 of the user terminal 200 operates as a vehicle selection unit F210, and outputs (displays) the first display screen including the vehicle list to the output device 205 (S101). As described above, the vehicle list is generated by using the vehicle data D200 held in the storage unit 202. That is, the vehicle selection unit F210 generates a list of all vehicles 10 (for example, vehicles A to D) included in the vehicle data D200 as a vehicle list. The vehicle list may be a list of selection buttons (selection buttons G11 to G14) corresponding to each of the vehicles 10 (vehicles A to D) associated with the user, as described with reference to FIG. 5. Then, the vehicle selection unit F210 outputs (displays) the first display screen including the generated vehicle list to the output device 205. Upon completion of S101 process, the vehicle selection unit F210 executes S102 process.

In S102, the vehicle selection unit F210 determines whether an operation of selecting one vehicle 10 from the vehicle list is input to the input device 204. The operation of selecting one vehicle 10 is, for example, an operation of clicking or tapping any one of the selection buttons G11 to G14 from the on the first display screen in FIG. 5. When the operation of selecting one vehicle 10 from the vehicle list is not input to the input device 204 (negative determination in S102), the vehicle selection unit F210 waits until the operation is input to the input device 204. On the other hand, when an operation for selecting one vehicle 10 from the vehicle list is input to the input device 204 (an affirmative determination is made on S102), the control unit 201 operates as the camera-selection unit F220 to execute S103 process.

In S103, the camera selection unit F220 outputs (displays) the second display screen including the camera list to the output device 205. Specifically, the camera selection unit F220 accesses the vehicle data D200 held in the storage unit 202, and specifies a record corresponding to the vehicle 10 selected by S102. Subsequently, the camera selection unit F220 specifies a field in which “1” is registered in the various camera fields of the specified record. The camera selection unit F220 generates a list of cameras (camera list) corresponding to the identified fields. Then, the camera selection unit F220 generates a second display screen including the generated camera list, and outputs (displays) the generated second display screen to the output device 205. As described with reference to FIG. 5, the second display screen may include a list of cameras (for example, a list of G22 from the selection-button G21 corresponding to each of the mounted cameras) mounted on the vehicle 10 designated by the user. The camera-selection unit F220 executes S104 process after S103 process is completed.

In S104, the camera selection unit F220 determines whether an operation of selecting one camera from the camera list is input to the input device 204. The operation of selecting one camera is, for example, an operation of clicking or tapping any one of G22 from the selection button G21 on the second display screen in FIG. 5. When the operation of selecting one camera from the camera list is not input to the input device 204 (negative determination in S104), the camera selection unit F220 waits until the operation is input to the input device 204. On the other hand, when an operation of selecting one camera from the camera list is input to the input device 204 (affirmative determination in S104), the control unit 201 operates as the video reproduction unit F230 to execute S105 process.

In S105, the video reproduction unit F230 transmits a delivery request including information specifying the vehicles 10 selected by S102 and the cameras selected by S104 to the server 100 through the communication interface 203. The vehicle 10 selected by S102 is, for example, the vehicle B selected on the first display screen in FIG. 5. The camera selected in S104 is, for example, the front camera selected in the second view in FIG. 5.

Here, the server 100 that has received the distribution request transmitted from the user terminal 200 transmits, to the vehicle 10 (for example, the vehicle B) designated by the distribution request, a command signal for causing the server 100 to transmit a video captured by the camera (for example, a front camera) designated by the distribution request in real time. Upon receiving the command signal from the server 100, the vehicle 10 (for example, the vehicle B) transmits a video captured by the camera (for example, a front camera) designated by the command signal to the server 100 in real time. The server 100 that has received the video transmitted from the vehicle 10 that has received the command signal transmits (relays) the received video to the user terminal 200 in real time.

Returning to the explanation of FIG. 6, the video reproducing unit F230 executes S106 process when S105 process is completed. In S106, the video reproduction unit F230 determines whether the communication interface 203 has received the video transmitted from the server 100. When the communication interface 203 has not yet received the video transmitted from the server 100 (negative determination in S106), the video reproduction unit F230 waits until the communication interface 203 receives the video transmitted from the server 100. On the other hand, when the communication interface 203 receives the video transmitted from the server 100 (affirmative determination in S106), the video reproducing unit F230 executes S107 process.

In S107, the video reproduction unit F230 outputs (displays) the third display screen including the reproduction screen of the video received from the server 100 to the output device 205. In one embodiment, the third display screen may include a playback screen of the video received from the server 100 (D1 in FIG. 5) and a GUI component (G31 to G32 in FIG. 5) for switching on/off of a predetermined device, as described with reference to FIG. 5. When the video reproducing unit F230 finishes executing S107 process, it executes S108 process.

In S108, the video reproduction unit F230 determines whether an on/off operation (for example, an operation of clicking or tapping an on-button G31 or an off-button G32 on the third display screen in FIG. 5) of a predetermined device is input to the input device 204. When an on/off operation of a predetermined device is input to the input device 204 (affirmative determination in S108), the video reproduction unit F230 executes S109 process. On the other hand, when an on/off operation of a predetermined device is not input to the input device 204 (negative determination in S108), the video reproducing unit F230 skips the processing of S109 and executes the processing of S110.

In S109, the video reproducing unit F230 transmits a manipulation request for turning on or off a predetermined device to the server 100. The operation request may include information specifying an on/off operation of the vehicle 10 selected by S102 and the predetermined device inputted by S108. The vehicle 10 selected by S102 is, for example, the vehicle B selected on the first display screen in FIG. 5. The on/off operation of the predetermined device is, for example, an on operation or an off operation of the headlight on the third display screen in FIG. 5.

Here, the server 100 that has received the operation request transmitted from the user terminal 200 transmits, to the vehicle 10 (for example, the vehicle B) designated by the operation request, a command signal (for example, a command signal for turning on or off the headlight) for causing a predetermined device to perform an operation in accordance with the operation designated by the operation request. The vehicle 10 (for example, the vehicle B) that has received such a command signal operates a predetermined device (for example, turns on or off the headlight) in accordance with the command signal.

Returning to the explanation of FIG. 6, when a negative determination is made in S108 and when S109 process is completed, the video reproducing unit F230 executes S110 process. In S110, the video reproduction unit F230 determines whether a predetermined period of time has elapsed since the reproduction of the video received from the server 100 started. As an example, the predetermined time length may be set to be shorter as the image quality of the video of the target camera is higher. When a predetermined length of time has not yet elapsed since starting reproduction of the video received from the server 100 (negative determination in S110), the video reproduction unit F230 executes the processes after S108 again. On the other hand, when a predetermined period of time has elapsed since the video received from the server 100 started to be reproduced (affirmative determination is made by S110), the video reproduction unit F230 executes S111 process.

In S111, the video reproduction unit F230 ends the reproduction of the video received from the server 100. In an exemplary embodiment, the video reproducing unit F230 may transmit a delivery stopping request to the server 100. The outage request may include information specifying the vehicle 10 selected in S102 (e.g., the vehicle B selected in the first display screen in FIG. 5) and the camera selected in S104 (e.g., the front camera selected in the second display screen in FIG. 5). The server 100 that has received such a delivery stop request may transmit, to the vehicle 10 (for example, the vehicle B) designated by the delivery stop request, a command signal for stopping the transmission of the video captured by the camera (for example, the front camera) designated by the delivery stop request to the server 100. The vehicle 10 (for example, the vehicle B) that has received such a command signal may stop the transmission of the video captured by the camera (for example, the front camera) designated by the designation signal to the server 100.

When the video reproducing unit F230 finishes executing S111 process, the process of FIG. 6 ends.

### Operation and Effect of Embodiments

According to the embodiment described above, the user terminal 200 can present the user with the camera list including only the cameras actually mounted on the vehicles 10 desired by the user through the program P200. Accordingly, the user terminal 200 can realize a user interface according to the number and/or type of cameras mounted on the vehicles 10 on which the user wants to view a video by executing the program P200. As a result, the convenience of the user in the parking monitoring service can be improved.

### Other

The above-described embodiment is merely an example, and the present disclosure can be appropriately modified and implemented without departing from the gist thereof. For example, the processing described as being performed by one apparatus may be performed by a plurality of apparatuses in a shared manner. Alternatively, the processes described as being executed by different devices may be executed by one device. In the computer system, it is possible to flexibly change the hardware configuration for implementing each function.

What is claimed is:

1. A non-transitory storage medium storing a program for causing a terminal used by a user to execute functions of:
accepting designation of a vehicle desired by the user, from among a plurality of vehicles associated with the user;
displaying a list of cameras installed in the vehicle that is designated;
accepting an operation of selecting a camera desired by the user from the list; and
performing playback of a video of the camera that is selected.

2. The storage medium according to claim 1, wherein the program further causes the terminal to execute shortening of playback time the higher image quality of the video of the camera that is selected is.

3. The storage medium according to claim 1, wherein the program causes the terminal to display a graphical user interface (GUI) component, for switching predetermined equipment installed in the vehicle on or off, during playback of the video of the camera that is selected.

4. The storage medium according to claim 3, wherein the program further causes the terminal to execute:
accepting operation of the GUI component; and
transmitting, to the vehicle, a command for switching the predetermined equipment on or off, in accordance with accepting the operation of the GUI component.

5. The storage medium according to claim 3, wherein,
when the camera that is selected is a camera that shoots forward of the vehicle,
the predetermined equipment is a headlight of the vehicle, and
the GUI component is a GUI component for switching the headlight on or off.
